(19) United States
(12) Patent Application Publication
(10) Pub. No.: US 2013/0316116 A1
(43) Pub. Date: Nov. 28, 2013

(54) Composite Ceramic Structure and Method of Manufacture

(71) Applicants: Richard Adams, Bolton, MA (US); James P Sorensen, Eagan, MN (US)

(72) Inventors: Richard Adams, Bolton, MA (US); James P Sorensen, Eagan, MN (US)

(21) Appl. No.: 13/890,028

(22) Filed: May 8, 2013

Related U.S. Application Data
(60) Provisional application No. 61/688,339, filed on May 11, 2012.

(51) Int. Cl. B26B 9/00; B32B 15/04; B32B 3/14; B32B 9/00; B32B 7/02; B32B 3/18

(52) U.S. Cl. CPC B26B 9/00; B32B 7/02; B32B 3/18; B32B 3/14; B32B 9/005; B32B 15/04
USPC 428/47; 428/212

(57) ABSTRACT

The Composite Ceramic Structure embodying the principles of the present invention includes a structural composite laminar sheet having top and bottom layers that are equivalent in number and have an identical positioning in the laminar sheet relative to the middle layer. These identically positioned top and bottom layers are further symmetric in both geometry and material composition to alleviate warping during expansion or contraction due to temperature change. At least one top and at least one bottom layers form a metal matrix composite (ₘ) and at least one middle layer (dense ceramic), impervious to metal infiltration, remains a dense ceramic (_{c}). The material combinations allow for the middle layer to have an in-plane residual compressive stress.

### CROSS-REFERENCE TO RELATED APPLICATIONS

This application claims the benefit of U.S. Provisional Application No, 61/688,339 filed 11 May 2012.

### FIELD OF THE INVENTION

This invention relates to a composite ceramic having a defined symmetry and structure to achieve in-plane residual compressive stress in the ceramic for increased strength and durability. In one embodiment, this invention relates to a structural composite laminar sheet having the properties of a monolithic ceramic but produced from a plurality of ceramic elements at a much lower cost.

### BACKGROUND OF THE INVENTION

The use of large sheets of monolithic ceramic composites and “structural ceramics” is necessary in a wide variety of structures; such as LCD manufacturing, handling arms in the semiconductor electronics industry, and ceramic blades.

Monolithic ceramic is a useful material because of its high stiffness arid resistance to wear, elevated temperature and corrosion. Commonly used ceramics such as alumina and silicon-carbide, for example, have specific stiffnesses more than four times higher than most metals (100 GPa/g/cc versus 25 GPa/g/cc), Ceramic materials also have very little property degradation at elevated temperatures up to about 1000° C.

Metals typically have significant property degradation at much lower temperatures. Aluminum for example is rarely used in structural applications above 175° C. Ceramics also have lower coefficients of thermal expansion (CTE) than most metals and thus are more dimensionally stable as temperature varies. Alumina, for example, has a CTE of about 8 ppm/° C. and silicon-carbide is about 2.5 ppm/° C. Steels range from 11-17 ppm/° C. and aluminum alloys are over 20 ppm/° C. Ceramics also have very high compression strength, exceeding almost all metal materials.

Ceramic materials, however, have some known disadvantages. They are weak in tension. They have low toughness and are sensitive to notches and other flaws. They are difficult to make in large sizes and so are expensive when large structural components are required. Further, ceramics are difficult to make to net-shape because of the shrinkage that occurs during sintering or hot-pressing, and thus require final machining. They are difficult to machine, usually requiring diamond cutting or grinding to final shape.

Metals and metal matrix composites on the other hand have excellent tensile strength and notch resistance and are more easily machined to provide attachments and design features.

Combining metal or metal matrix composites with ceramics to create a sandwich structure combines the benefits of each into a useful structural composite with benefits not previously available. Sandwich structures realize the benefits of multiple materials combined into a single structural composite. The resulting structural composite has increased strength and toughness not present in either the MMC or ceramic acting alone.

A sandwich structure is generally composed of a core layer which has a cover layer on the upper and lower sides respectively. Some examples of sandwich structures in the form of beams, plates, and shells can be found in a wide variety of products. In the aircraft industry, airplane wing control surfaces such as flaps or rudders often have a honeycomb core and aluminum or composite skin; in the acoustic industry the composite structures have specific audio characteristics; in the construction industry the composite structures have an insulation core and monolithic skin, such as drywall attached thereto; and in the furnace industry the composite structure may have a ceramic core and steel skin.

In the semiconductor and photovoltaic industry, the need for tooling, rigid fixtures and handling equipment made of ceramic materials is necessary in an environment where selectable thermal expansion, low or high thermal conductivity, high and low operating temperatures, resistance to thermal shock damage, and high strength to weight ratios, is required.

Specifically, in the semiconductor industry, end effectors made out of monolithic ceramics are utilized by robotic automation equipment for handling, holding, and processing wafers which may be anywhere from 300 mm to 450 mm in diameter. For example, one transfer robot used to handle flat panel substrates has a series of cantilevered end effectors.

However, the long end effectors required to adequately support large area substrates are subject to “droop” or sag. The sag of the end effector must be accommodated by a greater range of robotic motion and/or greater component clearance, both of which undesirably lead to higher tool costs. The monolithic ceramic sheet stock necessary for production of a large end effector devices to handle larger wafer sizes is cost prohibitive.

It is an object of the present invention to provide a composite sandwich structure which can foe used to produce an end effector having low sag, like the monolithic components, but not requiring a large monolithic piece of ceramic.

It is a further object of the present invention to provide a composite sandwich structure that can be used in the production of tooling and fixtures, where selectable thermal expansion, low or high thermal conductivity, high and low operating temperatures, resistance to thermal shock damage, and high strength to weight ratios, is required.

It is a further object of the present invention to provide a composite sandwich structure that can be used as a cutting or shear blade.

It is a further object of the present invention to provide a composite ceramic structure having a defined symmetry and structure to achieve in-plane residual compressive stress in the ceramic for increased strength and durability.

### SUMMARY OF THE INVENTION

In accordance with the present invention, a composite ceramic structure is produced by combining layers containing ceramic elements and layers containing only metal or metal matrix composite. The present invention can be used to produce low cost simple and complex parts with weight, stiffness and dimensional stability similar to expensive monolithic ceramic sheet stock. Certain properties such as bending strength, impact resistance and warpage due to temperature change will be enhanced due to the teachings of the present invention.

In accordance with a preferred embodiment of the present invention, briefly stated, a structural composite laminar sheet includes at least one top, at least one middle and at least one bottom stacked layers. The top and bottom layers are equivalent in number and have an identical positioning in the laminar sheet relative to the middle layer. These identically positioned top and bottom layers are further symmetric in both geometry and material composition to alleviate warping during expansion or contraction due to temperature change.

At least one of the middle layers is a substantially flat dense ceramic, and at least one of the top and bottom layers is a fibrous preform. The entire composite structure in the form of a sandwich includes a metal infiltrated within any intersticies in any layer. The metal infiltrant encases the composite structure binding the top, bottom, and middle layers together.

In the preferred embodiment, at least one top and at least one bottom layers form a metal matrix composite (ₘ) and at least one middle layer (dense ceramic), impervious to infiltration, remains a dense ceramic (_{c}). The dense ceramic middle layer has a modulus E_{c} and a total thickness t_{c}. The top and bottom layers have a modulus Eₘ and a total thickness tₘ, wherein the (coefficient of thermal expansion of Eₘ (CTEₘ) minus the coefficient of thermal expansion of E_{c} (CTE_{c}))*(Eₘ/E_{c})*(tₘ/t_{c}) is greater than 1 ppm/° C., resulting in the middle layer having an in-plane residual compressive stress.

The in-plane residual compressive stress, occurring in the middle layer increases the strength and durability of the composite laminar sheet.

In one embodiment, at least one middle layer comprises a plurality of monolithic ceramic in the form of dense ceramic tiles arranged in an array and may include spacing between adjacent tiles. The top and bottom layers may include reinforcement of fibrous ceramic. The infiltrant further penetrates the spacing between the plurality of dense ceramic tiles further securing the adjacent ceramic tiles.

The invention is best understood from the following detailed description when read in connection with the accompanying drawings, which illustrate various embodiments of the present invention:

### BRIEF DESCRIPTION OF THE DRAWINGS

FIG. 1 illustrates an exploded view of an embodiment illustrating the principles of subject invention and including a discontinuous ceramic middle layer, the discontinuous ceramic having space therebetween, bound by symmetric porous reinforcement layers, prior to metal infiltration.

FIG. 2 illustrates the discontinuous ceramic layer of FIG. 1 with the discontinuous ceramic having no space therebetween,

FIG. 3 illustrates a discontinuous ceramic layer having a zig-zag edge.

FIG. 4 illustrates a discontinuous ceramic layer having a curved edge.

FIG. 5 illustrates a sectional view of FIG. 1, after the layers are stacked upon each other, prior to metal infiltration.

FIG. 6 illustrates the embodiment of FIG. 5, subsequent to metal infiltration.

FIG. 7 illustrates a sectional view of FIG. 1, after the layers are stacked upon each other, and including the middle layer of FIG. 2, and subsequent to metal infiltration.

FIG. 8 illustrates an exploded view of an embodiment illustrating the principles of subject invention and including a middle layer of porous reinforcement, bound by symmetric layers of discontinuous ceramic having space therebetween.

FIG. 9 illustrates a sectional view of FIG. 8, after the layers are stacked upon each other, and subsequent to metal infiltration.

FIG. 10 illustrates an embodiment of the present invention having more than one top and bottom symmetric layers.

FIG. 11 illustrates a knife illustration of an application of the present invention, showing a small portion of ceramic placed locally where it is needed within the Nextel fibers.

FIG. 12 illustrates a knife illustration of an application of the present invention, showing a ceramic placed coextensive within the Nextel fibers.

### DETAILED DESCRIPTION OF THE INVENTION

The following detailed description illustrates the invention by way of example and not by way of limitation. This description will clearly enable one skilled in the art to make and use the invention, and describes embodiments, adaptations, variations, alternatives and uses of the invention, including what I presently believe is the best mode of carrying out the invention.

As various changes could be made in the above constructions without departing from the scope of the invention, it is intended that all matter contained in the above description or shown in the accompanying drawings shall be interpreted as illustrative and not in a limiting sense.

While not shown, those skilled in the art will understand that other sandwich structures within the scope of this invention are possible. In view of the foregoing, it will foe seen that the several objects of the invention are achieved and other advantageous results are obtained.

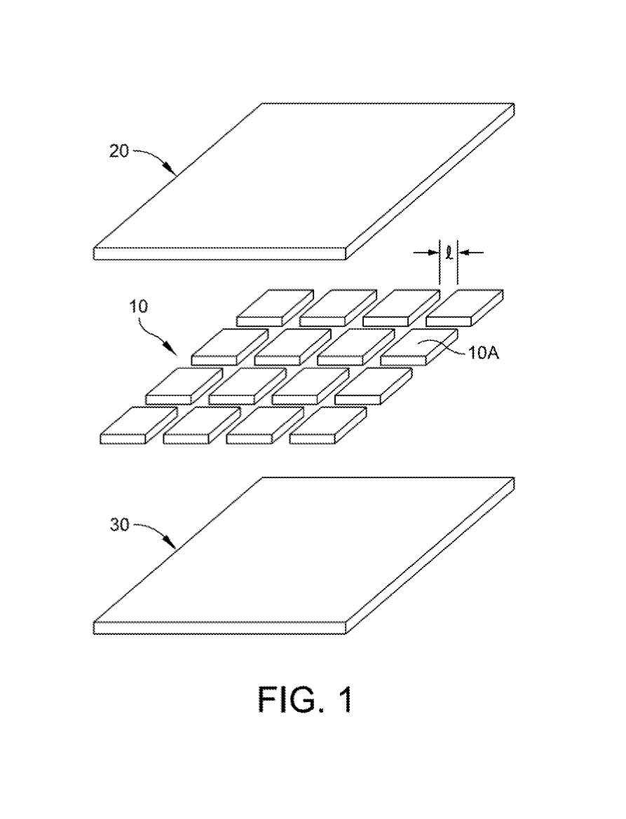

In one embodiment, a composite Laminer Sheet of FIG. 1 includes a middle layer 10, a top layer 20 and a bottom. layer 30, layers 20 and 30 being symmetric in both geometry and material composition. The top and bottom layers may include more than one layer, however the top number of layers, in the preferred embodiment, is equal to the bottom number of layers.

Further, each top layer and each bottom layer has an identical positioning in the laminar sheet relative to the middle layer, as illustrated in FIG. 10, These identically positioned top and bottom. layers are further symmetric in both geometry and material composition to alleviate warping during expansion or contraction due to temperature change,

As illustrated in FIG. 5 top layer 20 and bottom layer 30 are stacked upon middle layer 10 prior to being infiltrated with metal, in this embodiment, the middle layer comprises a plurality of monolithic ceramic in the form of a plurality of dense ceramic tiles IDA arranged in an array and may include spacing I between adjacent tiles. The symmetric top and bottom layer (s) 20, 30 may include reinforcement of fibrous ceramic, or other fibrous material as indicated herein,

FIG. 10 illustrates an embodiment of the composite laminar sheet of the present invention prior to metal infiltration. Each symmetric pair of top and bottom layers may include a different fibrous material type if desired. For example, top layer 20A and bottom layer 30A, being symmetric in both geometry and material composition, may have a different geometry and material composition than symmetric top layer 20B and bottom layer 30B.

As illustrated in FIG. 6, subsequent to metal infiltration, a composite structure is formed including at least one layer of metal or metal matrix composite 20, 30 and at least one layer made up of an array of individual pieces of monolithic ceramic 10. FIG. 6 illustrates, the molded composite structure of FIG. 1 and FIG. 5 subsequent to infiltration casting, having a metal therein denoted by “X”.

This composite structure includes a metal infiltrated within the fibrous ceramic forming the top and bottom layer(s) 20, 30 of Metal Matrix Composite (MMC). The ceramic layer 10 shows only surface bonding to the metal infiltrant and no infiltration within the interior of the dense material. The entire composite structure in the form of a sandwich includes a metal infiltrated within any intersticies in any layer. The metal infiltrant encases the composite structure binding the top, bottom, and middle layers together.

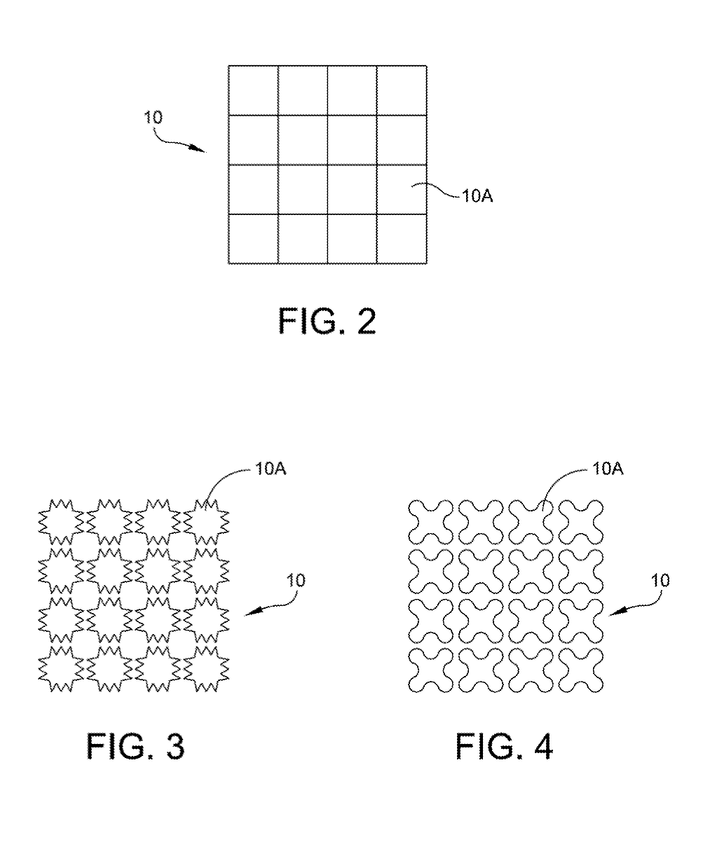

In this embodiment, the plurality of dense ceramic tiles 10A may be arranged such that no space exists between adjacent tiles, as illustrated by middle layer 10 of FIG. 2.

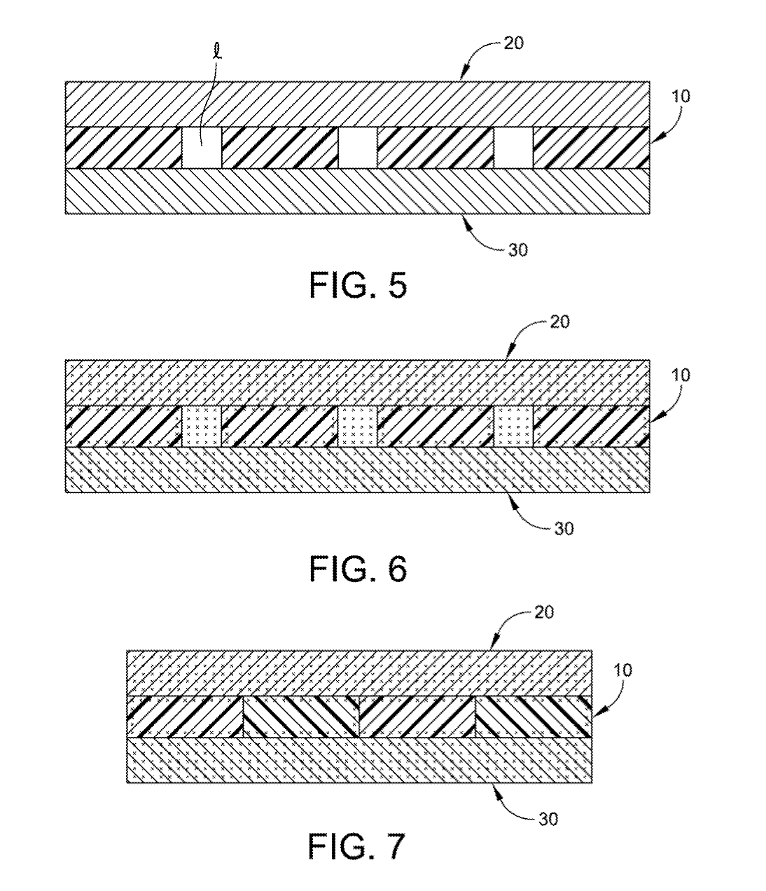

It is further contemplated that the dense ceramic tile layer 10 may comprise a plurality of tiles that do not have a straight line seam between adjacent tiles. Examples including zig-zagging the periphery of each tile (FIG. 3) or using any other non straight edge such as curved (FIG. 4) are contemplated. This will enhance the strength of joints between the ceramic tiles that are perpendicular to the loading direction.

It is further noted that the size of the individual tiles 10A could vary in dimension within the layer, and include a variety of edge types. It is further contemplated that the spacing between the tiles may further include additional reinforcement material such as a hollow microsphere material for energy absorption. The hollow microspheres are hermetic, and do not collapse or fill with metal during the metal infiltration process.

The hollow spheres have been demonstrated by the inventor to be strong enough to withstand the pressure of metal infiltration casting and will not soften or crush under extreme metal infiltration temperatures greater than 600 degrees Celsius. Furthermore, the hollow spheres do not degrade or dissolve due to chemical reactions with the metal infiltrant. Any ceramic or metallic bubble which is hermetic with the metal infiltrant, has sufficient crush strength, and acceptable reactivity with the infiltrant is acceptable.

Microspheres of the cenosphere variety are produced as a natural by-product of coal combustion during the generation of electric power. As a portion of the fly-ash generated in coal production, cenospheres are recycled from the waste stream. They are made up of inert silica, iron and alumina, and have a size ranging from 1 to 300 microns with an average compressive strength of 3000 PSI. Cenospheres of low bulk density are produced by Sphere Services, Inc, of Oakridge, Tenn.

Changing the density and stiffness of the material in the spaces between tiles, by adding hollow ceramic microspheres or cenospheres for example, will change the impedence value at the interfaces and modify the vibration and vibration damping properties.

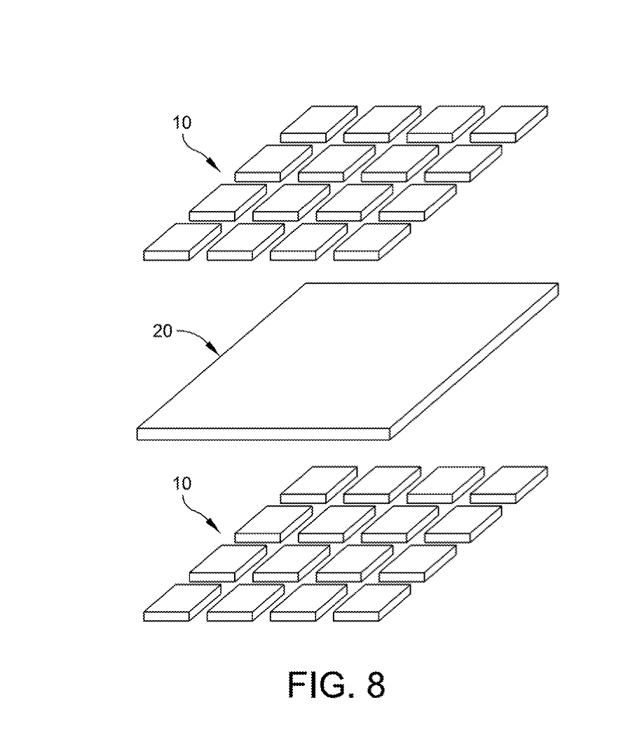

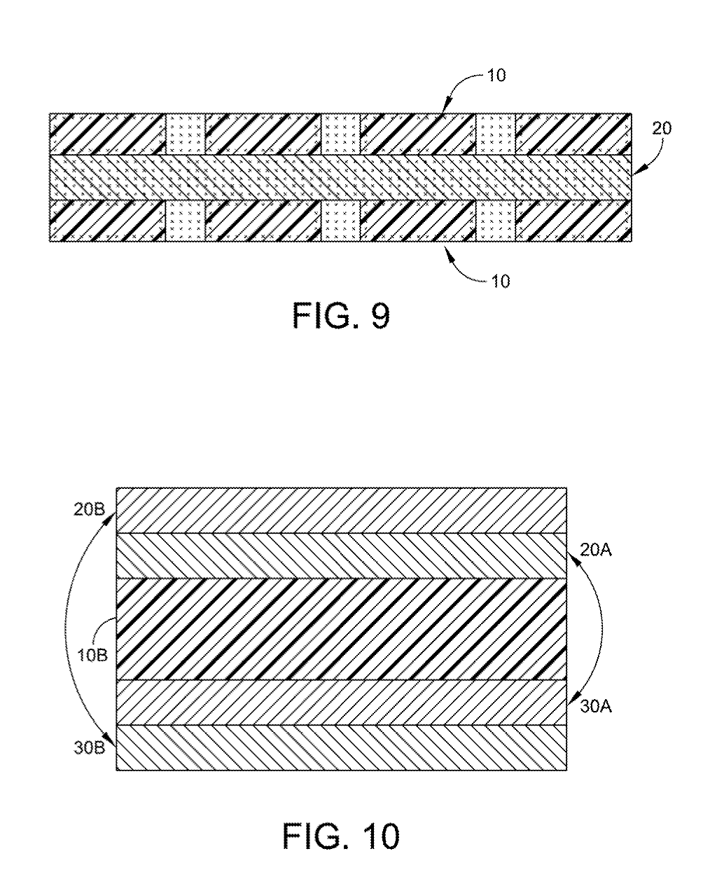

In another embodiment, as illustrated in FIG. 8, a top layer 10 and a bottom layer 10 comprise a plurality of dense ceramic tiles arranged In an array. In this embodiment the top and bottom layers are the symmetrical in both geometry and material composition. and may include spacing 1 between adjacent tiles.

The top and bottom layers may include more than one layer, however the top number of layers, in the preferred embodiment, is equal to the bottom number of layers, Further, each top layer and each bottom layer has an identical positioning in the laminar sheet relative to the middle layer. These identically positioned top and bottom layers are further symmetric in both geometry and material composition to alleviate warping during expansion due to temperature change. Each symmetric pair of top and bottom layers may include a different ceramic material type if desired.

In this embodiment, at least one middle layer (s) 20 includes the reinforcement layer of fibrous ceramic. Top layer(s) 10 and bottom layer(s) 10, may also include different configurations of tiles as previously described and illustrated in FIGS. 3 and 4. The tiles may also include space therebetween and this composite structure also includes a metal infiltrated within the fibrous ceramic forming the middle layer 20 of Metal Matrix Composite (MMC).

The ceramic layer(s) 10 shows only surface bonding to the metal infiltrant (FIG. 9) and no infiltration within the interior of the dense material. The entire composite structure in the form of a sandwich includes a metal infiltrated within any inters tides in any layer. The metal infiltrant encases the composite structure binding the top, bottom, and middle layers together.

In another embodiment, the top and bottom layers comprise the dense ceramic tiles arranged in an array as previously described and the middle layer 20 consists only of a very thin aluminum layer. The aluminum layer acts only to bind the entire assembly together, in a manner similar to brazing. In this embodiment, this middle layer is between 0.1 mm and 0.6 mm

In the preferred embodiment, the individual ceramic tiles in the layer(s) comprising a plurality of ceramic tiles have dimensions from about 25 mm to about 115 mm and thickness from about 0.25 mm to about 2 mm, most preferably from about 0.5 mm to about 1 mm.

In the embodiment where the MMC layer(s) are the top and bottom layers the MMC layer(s) each have a thickness between about 0.25 mm and 2 mm, preferably between about 0.5 mm and about 1 mm. In the embodiment where the MMC layer(s) is the middle layer, the MMC layer(s) each have a thickness between 0.25 and 10 mm. There is no preferred, thickness, because the thickness of this core layer will depend on the overall structural and stiffness requirements of the application.

The spacing between the tiles is from 0 to about 1 mm. Ceramics are much stronger in compression than in tension, so putting the ceramic into residual compression will give it greater strength and durability. Therefore in all embodiments of this invention, it is desired to fabricate a sandwich structure with an in-plane residual compressive stress in the monolithic ceramic pieces or tiles.

Since the fabrication is done at high temperature, above the melt temperature of aluminum, residual stress in the ceramic layer will be compressive if the coefficient of thermal expansion (CTE) of the metal or metal matrix composite (MMC) layer(s) is greater than the CTE of the ceramic. The magnitude of the compressive stress will be proportional to the differences in coefficient of thermal expansion (CTE) between the ceramic and metal or MMC layer(s) and in the relative thicknesses and material stiffness of the layers.

The in-plane residual compressive stress, occurring in the middle layer increases the strength and durability of the composite laminar sheet.

In the preferred embodiment, at least one top and at least one bottom layers form a metal matrix composite (ₘ) and at least one middle layer (dense ceramic), impervious to infiltration, remains a dense ceramic (_{c}). The dense ceramic middle layer has a modulus E_{c} and a total thickness t_{c}. The top and bottom layers have a modulus Eₘ and a total thickness tₘ, wherein the (coefficient of thermal expansion of Eₘ (CTEₘ) minus the coefficient of thermal expansion of E_{c} (CTE_{c}))*(Eₘ/E_{c})*(tₘ/t_{c}) is greater than 1 ppm/° C., resulting in the middle layer having an in-plane residual compressive stress.

The decision to put ceramic layers as the outermost layers or to put metal or MMC as the outermost layers of the composite structure depends on the purpose of the resulting structure. If bending stiffness is the primary requirement, ceramic on the outside will give the greatest bending stiffness. If bending strength is the primary requirement, then high strength MMC layers would be preferred on the outside.

It is further contemplated a process for producing a shaped article from a composite structure. The composite structure of the present invention is created utilizing a molten metal infiltration process. First, a mold cavity is provided. Next, a composite structure, as described above, in the preferred embodiment, is arranged within the mold cavity.

The dense ceramic tiles are positioned within the composite structure, in the preferred embodiment, to create a controlled space between adjacent tiles. The fibrous ceramic layers can either be the top and bottom layers or the middle layer as previously described, with the outermost layers being symmetrical in both geometry and material composition. The spacing between the tiles may further include additional, reinforcement material such as a hollow microsphere material for energy absorption.

In some embodiments, stainless steel or titanium, tubes may be places in individual layers, in holes or slots cut into certain ceramic tiles, or in the spaces between tiles prior to metal infiltration. After completion of the infiltration step, fiber optic or other sensors can foe added within the tubes. Similarly, stainless steel or titanium plates or plugs can foe placed into the reinforcement layers of fibrous ceramic before infiltration to provide a place for machining attachment features in the finished part.

The mold cavity is next infiltrated under pressure with molten metal allowing for metal to penetrate into any open porosity of the dense ceramic tiles surfaces, and spaces therebetween, and within the open porosity of the reinforcement layers of fibrous ceramic. The metal binds the layers together, encapsulating the dense ceramic tiles to form, the composite structure. Suitable metal infiltrants include but are not limited to aluminum alloys, copper, titanium and magnesium, and other metal alloys cast from the molten liquid phase. The liquid metal infiltration process is described in U.S. Pat. No. 3,547,180 and incorporated herein by reference for all that it discloses.

The mold chamber may be fabricated to create the final shape or closely approximate that desired of the final product. The composite structure is next demolded and comprises a hybrid structure of metal matrix composite and ceramic tiles with an encapsulating aluminum rich skin. The demolded composite structure may require additional machining or finishing, such as trimming to final shape, drilling and tapping holes in metal inserts for attachment features, or cutting open the embedded tubes and adding fiber optic sensors. Ordinary methods known in the art can be used, such as abrasive waterjet, diamond coated cutting wheels or grinding wheels.

The dense ceramic tiles may comprise inorganic material systems such as ceramics, metals, carbon/graphite materials, or composites with dense microstructures. The tile geometries can be in the form of flat plates of varying thickness. The selection of different dense material types allows the designer to vary thermal expansion coefficients throughout the structure to create varying stress states for increased effectiveness.

The selection of different material types may also be based on hardness, strength, toughness, and weight attributes of the individual material types. Examples of the fibrous ceramic layer(s) include but are not limited to 15-70 percent of continuous ceramic fiber, such as Nextal, or 3-40 percent of discontinuous ceramic fibers, such as SiC or Bn, or 20-70 percent volume of ceramic particles.

### EXAMPLES

### Example 1

A rectangular mold is used with cavity dimensions of 300×200×2.0 mm. A layer having a plurality of alumina tiles, with each tile having a dimension 25×25×0.5 mm, is placed into the mold in an array. On top of the array of alumina tiles is placed two layers of ceramic fiber fabric (Nextel Ceramic Fiber fabric DF-19, from 3M company, St. Paul, Minn.), each cut to 300×200 mm. Next another layer of the alumina tiles (25×25×0.5 mm) are placed over the ceramic fiber fabric and the mold is closed. The mold is then infiltrated with molten aluminum using methods known in the art at a pressure of 50-60 bar and allowed to cool and solidify. The resulting sandwich is a 2 mm thick plate of 200×300 mm. Next an end effector is machined from the plate by cutting out the shape using abrasive waterjet.

### Example 2

Example 2 is similar to example one except that the Silicon-Carbide ceramic tiles are used rather than alumina.

### Example 3

A mold with a cavity depth of 2.0 mm and the outline shape of an end effector is used; a two pronged spatula shape of approximately 150 mm×250 mm overall dimension. One piece of Nextel DF-19 fabric is cut to the shape of the mold and placed into the bottom of the mold. Then a single layer of a plurality of silicon-carbide tiles are placed info the mold.

The silicon-carbide tiles are 0.5 mm thick and have been laser cut into a ‘kit’ containing multiple shapes, that when placed together, fill the cavity completely. Finally a second piece of Nextel DF-19 fabric cut to the same shape as the first layer is placed into the mold, on top of the layer of Silicon Carbide tiles, and the mold is closed. The mold is then infiltrated with molten aluminum using methods known in the art at a pressure of 50-60 bar and allowed to cool and solidify. The resulting sandwich is a semi finished end effector. Further machining to add attachment or other features will finish the component.

### Example 4

Example 4 is similar to example 3 except that the Nextel fabric layers are replaced with a layer of discontinuous ceramic fiber paper or matt cut to the same shape and dimensions. Saffil paper of matt can foe obtained from Unifrax, Niagara Fails, N.Y.

### Example 5

Is similar to example one except that shims of 0.5 mm. thickness are placed between the tiles in the top and bottom layers in order to create a 0.5 mm gap between tiles. Then the gap is filled with silicon carbide particles and the shims removed before the mold is closed.

### Example 6

Example 6 is similar to example 5 except that low density ceramic microspheres are placed between the tiles rather than silicon-carbide particles.

Ceramic is an excellent cutting material because of it's high hardness and ability to be ground to a sharp edge. But, it is too brittle to generally be used as a cutting or shearing blade. However, placing it between layers of Metal Matrix Composite Fiber preform and then infiltrating the entire sandwich will create a one piece material tough enough to withstand normal use but able to be sharpened and used like a ceramic knife. As described previously in subject application, the requirement that the layers be asymmetric is preferred, however, but is not required. Asymmetric laminates may warp a little, but for a blade it may be acceptable.

For subject blade disclosure a continuous piece of ceramic may be substituted for a plurality of ceramic pieces or tiles as middle layer as described previously, the pieces either touching or having space therebetween (with spacing therebetween, and metal infiltrated in spacing, through thickness reinforcement helps keep the blade from splitting apart. Examples for plurality of ceramic pieces for center layer include large cutting blades, or blades with serrated edges.

### Example 7

Place at least one of Hextel 20,000 Denier ceramic fiber fabric, or equivalent, on either side of the ceramic layer, preferably multiple thin plies of Nextel, then infiltrate the composite. Multiple layers, when sharpened, will have the individual layers exposed and it would have that laminated look, like Japanese kitchen knives.

Place the Nextel layers in a mold that is approximately 250 mm×50 mm (other mold sizes can be used), Next, place the ceramic layer of silicon Carbide or alumina ceramic on top of the Hextel fabric layers. This ceramic piece is 250 mm×50 mm×1 mm. Next place additional layers of the Nextel 20,000 ceramic fiber fabric on top of the ceramic. The multiple stacked layers, or preform, is then compressed to get a dense, high quality MMC after metal infiltration, The lid is next placed on the mold. The entire mold and preform is heated to the melting point of aluminum and then liquid aluminum is injected into the mold under pressure to fill ail the interstices in the preforms and to bond the ceramic layer to the MMC layers.

After cooling the resulting sandwich can be cut to shape and ground on the edge to expose the ceramic core and create the cutting edge. Holes can then be drilled in the blade, using diamond core drills, and a handle attached if a knife is desired.

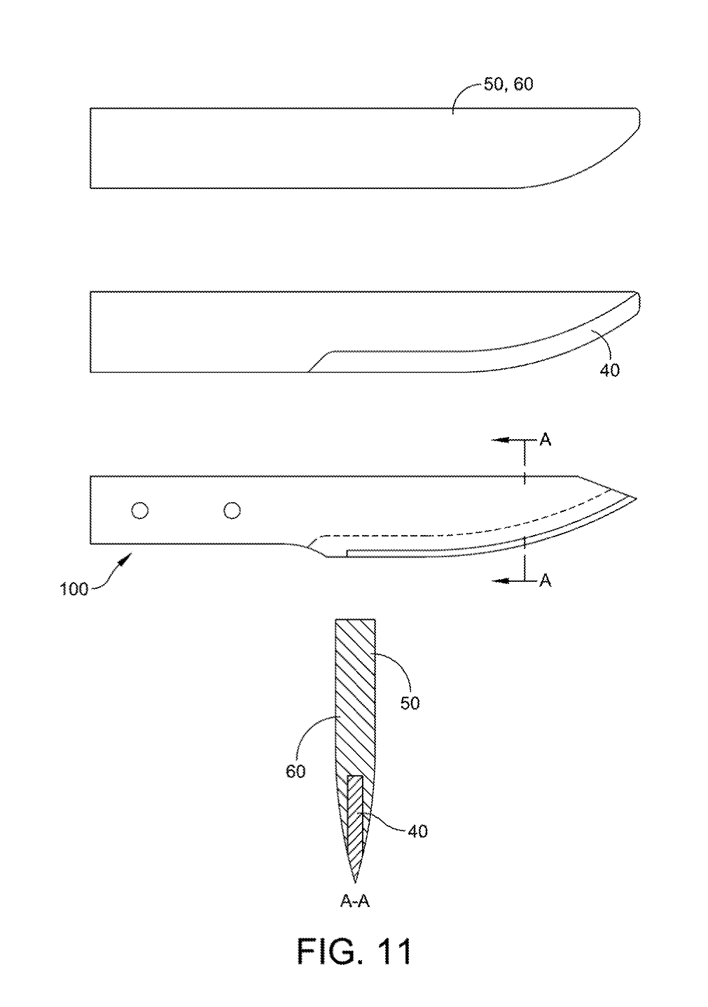

FIG. 11 illustrates, a blade 100 where the ceramic layer 40 is placed locally where it is needed between the preform of Nextel fibers 50, 60.

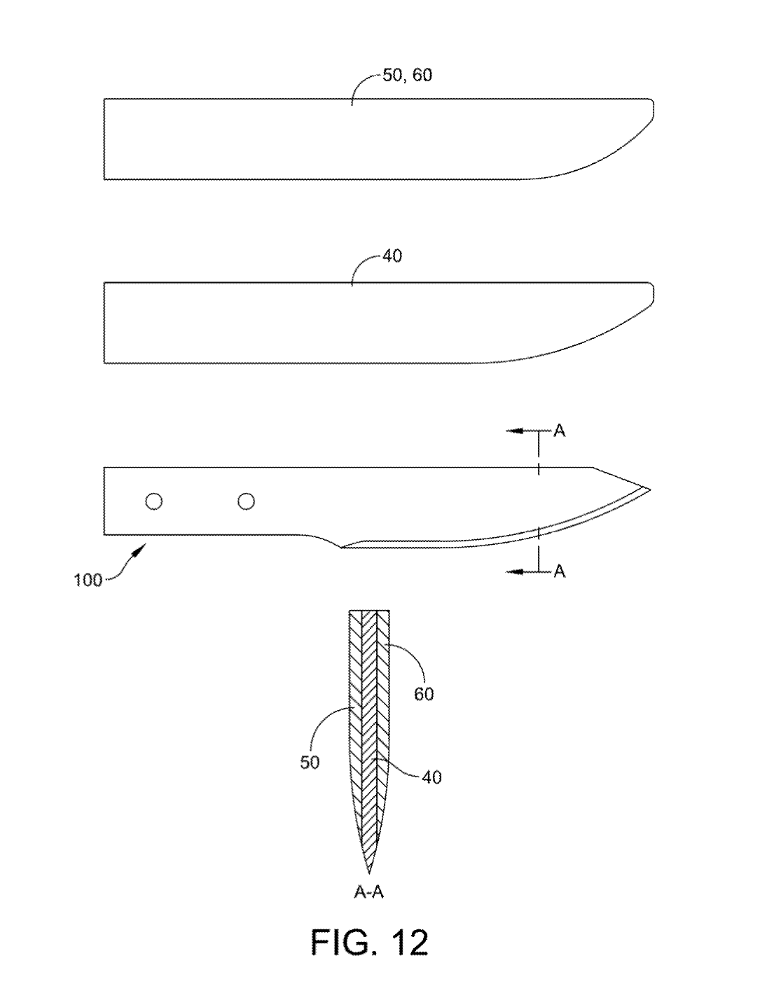

FIG. 12 illustrates, a blade 100, showing a ceramic layer 40 placed coextensive and between the performs of Nextel fibers 50, 60.

### Example 8

Similar to Example 7 except the center layer is not a continuous piece of ceramic, but the ceramic is only placed along the edge but still a continuous piece, but only on. edge.

I claim:

1. A Structural Composite Laminar Sheet, comprising:
at least one top, at least one middle and at least one bottom stacked layers, each of said, at least one top layers and each of said at least one bottom layers having an identical positioning in said stacked layer relative to said at least one middle layer, said identical positioned each of said at least one top layers and each of said at least one bottom layers being symmetric in both geometry and material composition,
Said at least one middle layer comprising a substantially flat dense ceramic;
Said at least one top and at least one bottom layers comprising at least one layer of fibrous preform;
Said at least one top, at least one middle, and at least one bottom layers forming a composite structure, said composite structure further comprising a metal infiltrated therein to bind said composite structure, said at least one top and at least one bottom layers form a metal matrix composite (ₘ) and said at least one middle layer, impervious to infiltration, remains a dense ceramic (_{c}), said at least one dense ceramic middle layer having a modulus E_{c} and total thickness t_{c}, said at least one top and at least one bottom layers having a modulus Eₘ and a total thickness tₘ, wherein the (coefficient of thermal expansion of Eₘ (CTEₘ) minus the coefficient of thermal expansion of E_{c} (CTE_{c}))*(Eₘ/E_{c})*(tₘ/t_{c}) is greater than 1 ppm/° C., resulting in said at least one middle layer having an in-plane residual compressive stress.

2. A Structural Composite Laminar sheet as in claim 1, wherein said at least one middle layer of substantially flat dense ceramic includes a plurality of substantially fiat discontinuous dense ceramic tiles.

3. A Structural Composite Laminar sheet as in claim 2, wherein said plurality of substantially flat discontinuous dense ceramic tiles include spacing therebetween.

4. A Structural Composite Laminar sheet as in claim 2, wherein said plurality of discontinuous dense ceramic tiles comprise curved edges.

5. A Structural Composite Laminar sheet as in claim 2, wherein said plurality of substantially flat discontinuous dense ceramic tiles include no space therebetween.

6. A Structural Composite Laminar sheet as in claim 3, wherein said spacing is filled with hollow ceramic cenospheres.

7. A Structural Composite Laminar sheet as in claim 2, wherein said plurality of ceramic tiles range in dimensions from about 25 mm to about 115 mm width and from about 0.25 mm to about 2 mm in thickness.

8. A Structural Composite Laminar sheet as in claim 3, wherein said spacing between tiles is 1 mm or less.

9. A Structural Composite Laminer sheet as in claim 2, wherein said plurality of ceramic tiles further include slots, said slots including tubes therein.

10. A Structural Composite Laminar Sheet, comprising:
at least one top, at least one middle and at least one bottom stacked layers, each of said at least one top layers and each of said at least one bottom layers having an identical positioning in said stacked layers relative to said at least one middle layer, said identical positioned each of said at least one top layers and each of said at least one bottom layers being symmetric in both geometry and material composition,
Said at least one middle layer comprising a fibrous perform;
Said at least one top and at least one bottom layers comprising at least one layer of substantially flat dense ceramic;
Said at least one top, at least one middle, and at least one bottom layers forming a composite structure, said composite structure further comprising a metal infiltrated therein to bind said composite structure, said at least one middle layer forms a metal, matrix composite (ₘ), and said at least one top and said at least one bottom layers, impervious to infiltration, remain a dense ceramic (_{c}), said at least one dense ceramic top and said dense ceramic bottom layers having a modulus E_{c} and total thickness t_{c}, said at least one middle layer having a modulus Eₘ and a total thickness tₘ, wherein the (coefficient of thermal expansion of Eₘ (CTEₘ) minus the coefficient of thermal expansion of E_{c} (CTE_{c}))*(Eₘ/E_{c})*(tₘ/t_{c}) is greater than 1 ppm/° C., resulting in said at least one top and said at least one bottom layers having an in-plane residual compressive stress.

11. A Structural Composite Laminar sheet as in claim 10, wherein said substantially fiat dense ceramic includes a plurality of substantially flat discontinuous dense ceramic tiles.

12. A Structural Composite Laminar Sheet as in claim 10, wherein said at least one middle layer comprises thin aluminum between about 0.1 mm to about 0.6 mm in thickness.

13. A. composite blade, comprising:
at least one top, at least one middle and at least one bottom stacked layers;
said at least one middle layer comprising a substantially flat dense ceramic;
Said at least one top and at least one bottom layers comprising at least one layer of fibrous preform;
Said at least one top, at least one middle, and at least one bottom layers forming a composite structure, said composite structure further comprising a metal infiltrated therein to bind said composite structure, said at least one top and at least one bottom layers form a metal matrix composite (ₘ) and said at least one middle layer, impervious to infiltration, remains a dense ceramic (_{c}), said at least one dense ceramic middle layer having a modulus E_{c} and total thickness t_{c}, said at least one top and at least one bottom layers having a modulus Eₘ and a total thickness tₘ, wherein the (coefficient of thermal expansion of Eₘ (CTEₘ) minus the coefficient of thermal expansion of E_{c} (CTE_{c}))*(Eₘ/E_{c})*(tₘ/t_{c}) is greater than 1 ppm/° C., resulting in said at least one middle layer having an in-plane residual compressive stress,
said composite blade further including a cutting edge.

14. A composite blade, according to claim 13, wherein each of said at least one top and each of said at least one bottom layers have an identical positioning relative to said at least one middle layer, said identical positioned each of said at least one top layers and each of said at least one bottom layers being symmetric in both geometry and material composition.

15. A composite blade, according to claim 13, wherein said at least one middle layer of substantially flat dense ceramic includes a plurality of substantially flat discontinuous dense ceramic tiles.

16. A composite blade according to claim 13, wherein a portion of said dense ceramic tiles is replaced with a fibrous preform.
